(19) United States
(12) Patent Application Publication
(10) Pub. No.: US 2026/0220176 A1
(43) Pub. Date: Jul. 30, 2026

(54) COMPUTING DEVICE AND METHOD FOR TEXT-TO-SQL SEMANTIC PARSING

(71) Applicant: HUAWEI TECHNOLOGIES CO., LTD., Shenzhen (CN)

(72) Inventors: Pavlos Vougiouklis, Edinburgh (GB); Zhili Shen, Shenzhen (CN); Chenxin Diao, Shenzhen (CN); Kaustubh Vyas, Munich (DE); Yuanyi Ji, Beijing (CN); Jeff Pan, Edinburgh (GB)

(73) Assignee: HUAWEI TECHNOLOGIES CO., LTD., Shenzhen (CN)

(21) Appl. No.: 19/574,782

(22) Filed: Mar. 23, 2026

Related U.S. Application Data
(63) Continuation of application No. PCT/EP2024/066463, filed on Jun. 13, 2024.

(51) Int. Cl. G06F 16/3332; G06F 40/205

(52) U.S. Cl. CPC G06F 16/3334; G06F 40/205

(57) ABSTRACT

A computing device configured to receive a database query in a natural language and database information, the database information including a database schema having multiple schema elements, and receive a preliminary query in structured query language corresponding to an input query. The computing device is configured to select schema elements, and select examples, each including a respective pair of natural language queries and structured query language queries, based on respective structural similarities between the preliminary query and a structured query language query of a respective pair represented as normalized abstract syntax trees. The computing device is configured to form a prompt based on the selected schema elements and examples, and input the prompt to a large language model to form an output query in the structured query language.

### CROSS-REFERENCE TO RELATED APPLICATIONS

This application is a continuation of International Application No. PCT/EP2024/066463, filed on Jun. 13, 2024, the disclosure of which is hereby incorporated by reference in its entirety.

### FIELD

The present disclosure relates to semantic parsing, particularly in the formation of database queries in structured query language.

### BACKGROUND

Structured query language (SQL) is a programming language for storing and processing information in databases. In relational databases, information is stored in one or more tables, with rows and columns of the table(s) representing different data attributes. SQL is used to communicate with a database.

The task of Text-to-SQL semantic parsing is concerned with transforming natural language questions into queries in structured query language. The resulting SQL queries can be executed by a corresponding database instance, in order for appropriate results to be returned to the end-user, who might not necessarily be familiar with SQL or the schema of the given database. Given their accessibility benefits, Text-to-SQL applications have become increasingly popular.

The success of Large Language Models (LLMs) in generalising across diverse Natural Language Processing (NLP) tasks has fuelled research looking at how multi-billion parameter models can be best employed in Text-to-SQL scenarios and how including suitable (question, SQL) example pairs when prompting LLMs can lead to performance improvements.

Conventional solutions for the selection of examples to be included in a prompt for input to a LLM, such as that described in Guo, C., Tian, Z., Tang, J., Li, S., Wen, Z., Wang, K., & Wang, T. (2024), “Retrieval-Augmented GPT-3.5-Based Text-to-SQL Framework with Sample-Aware Prompting and Dynamic Revision Chain”, in B. Luo, L. Cheng, Z.-G. Wu, H. Li, & C. Li (Ed.), Neural Information Processing (pp. 341-356), Singapore: Springer Nature Singapore, have focused on retrieving pairs using masked question similarity (i.e. mentions that are between quotation marks or other numerical values are masked during similarity computations). Other approaches have sought to approximate expected SQL queries, and directly use these approximations in the prompt, in a few-shot setting (see Sun, R., Arik, S. Ö., Muzio, A., Miculicich, L., Gundabathula, S., Yin, P., Pfister, T. (2024), “SQL-PaLM: Improved Large Language Model Adaptation for Text-to-SQL (extended)”, <https://arxiv.org/abs/2306.00739>) or to subsequently select (question, SQL) pairs by taking into consideration the similarity of their corresponding SQL query skeletons against the skeleton of the approximated SQL query (see Gao, D., Wang, H., Li, Y., Sun, X., Qian, Y., Ding, B., & Zhou, J. (2023), “Text-to-SQL Empowered by Large Language Models: A Benchmark Evaluation”, CoRR, abs/2308.15363). While incorporating SQL skeleton similarity has led to improvements over conventional example selection approaches for Text-to-SQL applications, it can result in structural information loss. This is exemplified in Table 1, provided below, which shows an example of two SQL queries with identical SQL skeletons. SQL (1-2) are identical in the case that overlap token ratio of these simplified skeletons is used for computing their in-between similarity.

TABLE 1

| | |
|---|---|
| SQL₁ | SELECT T2.name, T2.capacity FROM concert AS T1 JOIN stadium |
| | AS T2 ON T1.stadium_id = T2.stadium_id WHERE T1.year >= 2014 |
| | Skeleton: select_from_where_{—} |
| SQL₂ | SELECT name FROM highschooler WHERE grade = 10 |
| | Skeleton: select_from_where_{—} |

Research has looked at various aspects of prompt enhancement that would enable LLMs to generalise better to the requirements of unseen databases. Schema linking (or pruning) has maintained a prominent place among such enhancements due to its traditional performance benefits for semantic parsing tasks, particularly: (i) filtering out schema elements which would be unnecessary for answering a particular question, and, consequently, simplifying the semantic parsing task for latent Text-to-SQL models, and (ii) handling longer schemata (having ≥200 columns) which would not be processable by LLMs with shorter context windows (i.e. <2 k tokens).

From the perspective of LLMs, existing approaches generally achieve improvements by including the full database schema in the prompt, while pure schema pruning strategies usually result in performance degradation.

Some prior methods have sought to either retrieve or highlight in the resulting prompt the most relevant schema elements for answering an input natural language question. The approach described in Pourreza, M., & Rafiei, D. (2023), “DIN-SQL: Decomposed In-Context Learning of Text-to-SQL with Self-Correction”, <https://arxiv.org/abs/2304.11015>, included schema selection considerations by incorporating a step that, in a chain-of-thought prompting setup, identifies mentions of tables, columns or values that were explicitly mentioned in the text. The approach described in Sun, R., Arik, S. Ö., Muzio, A., Miculicich, L., Gundabathula, S., Yin, P., Pfister, T. (2024), “SQL-PaLM: Improved Large Language Model Adaptation for Text-to-SQL (extended)”, <https://arxiv.org/abs/2306.00739>, looked at how column selection using either a dense retriever or the schema elements included in an approximated SQL query (provided by an LLM) can be carried out as a preceding step to the main Text-to-SQL parsing task. However, improvements were noted only when hints about schema elements of interest (i.e. soft column selection, where the full schema is still used) were provided in the prompt, and performance degraded with schema pruning strategies.

In order to provide further quality guarantees, Text-to-SQL systems usually seek to investigate the executability of the resulting SQL query against database instances. Further SQL revisions can be performed in case the SQL query is not executable or results inconsistencies are observed. While these approaches can result in SQL execution accuracy improvements, access to an executable database environment is not always available across all deployment requirements. Furthermore, attempting multiple query executions can result in unnecessary load for the database instance, negatively impacting its throughput.

Many recent approaches do not provide any considerations for database schema selection. As a result, in the case of longer input database schema, the chance of an LLM to concentrate on more critical information is reduced due to the added noise and/or the prompt length might be insufficient to accommodate the full schema leading to truncation practices and input information loss. Many existing solutions also do not provide a way to identify problematic SQL queries, without pre-requesting the existence of an executable database, before they are returned to the end-user.

It is desirable to develop an approach that may overcome at least some of the above issues.

### SUMMARY

According to a first aspect, the present disclosure provides a computing device comprising one or more processors configured to perform the following steps: receive a database query in a natural language and database information, the database information comprising a database schema having multiple schema elements; receive a preliminary query in structured query language corresponding to the input query; select one or more schema elements from the multiple schema elements; select one or more examples from multiple indexed examples, each example of the multiple indexed examples comprising a respective pair of natural language and structured query language queries, in dependence on respective structural similarities between the preliminary query and the structured query language query of a respective pair of multiple preliminary examples of the multiple indexed examples, wherein the preliminary query and the structured query language query of a respective pair are represented as normalized abstract syntax trees; form a prompt based on the selected one or more schema elements and the selected one or more examples; and input the prompt to a large language model to form an output query in structured query language corresponding to the input query.

This may allow output queries to be formed using examples in the prompt that have semantic similarity with respect to both the input query and the expected SQL, with the ability to support new domains with limited data.

The one or more processors may be further configured to refine the output query in dependence on a similarity score between the preliminary query and the output query. This may allow for the identification of problematic queries without requiring access to an executable database and may iteratively improve problematic SQL queries.

The one or more processors may be configured to compute the similarity score between the preliminary query and the output query by representing each of the preliminary query and the output query as respective abstract syntax trees and determining the structural similarity of the respective abstract syntax trees. This may allow for a more representative determination of similarity between the input query and the output query than, for example, using skeletons of the queries, which may result in information loss.

If the similarity score meets a threshold, the one or more processors may be configured to provide the output query for execution by a database instance corresponding to the database information. This may help to ensure that only accurate queries are executed by the database instance.

If the similarity score does not meet a threshold, the one or more processors may be configured to repeat the steps above using the output query as the preliminary query. This may allow problematic queries to be iteratively improved.

The one or more processors may be configured to repeat the steps defined in the first aspect until the similarity score between the preliminary query and the output query is greater than or equal to the threshold, or until a pre-determined number of iterations has been performed. This may allow problematic queries to be iteratively improved until they meet an expected threshold.

If the similarity score is lower than the threshold, the one or more processors may be configured to output a warning message. This may allow the device to still provide the output query, but with a warning to the user that the quality may be lower than desired.

The one or more processors may be configured to select the one or more examples by: retrieving the multiple preliminary examples from the multiple indexed examples based on an embedding similarity between the input query and the natural language query of a respective pair of the multiple indexed examples; and re-ranking the multiple preliminary examples in dependence on the structural similarity between the preliminary query and the structured query language query of a respective pair of the multiple preliminary examples represented as normalized abstract syntax trees. This approach for re-ranking examples retrieved by question similarity, using similarity of normalized SQL Abstract Syntax Trees (ASTs), considering the similarity of such hierarchical structures, may significantly refine an LLM's performance for Text-to-SQL cases and help to ensure semantic similarity with respect to both the input question and the expected SQL.

The one or more processors may be configured to select the one or more schema elements in dependence on structured query language operations relevant to each of the multiple schema elements. This may result in more refined input format for large language models. This may also improve SQL execution accuracy and allow for supporting large schemata, for example having ≥200 columns. Schema selection may also consider methodologies for coupling the results of a dense or sparse retriever, or combinations thereof, with a model predicting candidate SQL operation labels for each schema element. The retrievers may consider a semantic representation of each column in the original schema, for example by aggregating the table name that it belongs to, its semantic name and its corresponding value set in the relevant database.

The one or more processors may be configured to include the structured query language operations relevant to the selected schema elements in the prompt. This may enrich the prompt to provide a more accurate output query.

The one or more processors may be configured to determine the structural similarity between the preliminary query and the structured query language query of each pair each represented as respective abstract syntax trees based on the sizes of the respective abstract syntax trees and the number of changes between the respective abstract syntax trees. This may allow the similarity between the preliminary query and the structured query language query of each pair to be determined in a more representative manner.

The one or more processors may be further configured to cause the output query to be executed by the database instance corresponding to the database information. This may allow database results corresponding to user queries to be provided to a user and/or to be used for subsequent operations at the computing device.

The input query may be in a different natural language to the database schema. This may allow output queries to be formed where the user input is in a different language to the schema.

The database information may further comprise database content. The one or more processors may be further configured to select one or more parts of the database content for inclusion in the prompt. This may enrich the selected schema elements.

The one or more processors may be configured to select database values for columns in the one or more selected schema elements by performing keyword matching between the input query and each value of a respective column. This may allow relevant database values to be included in the prompt.

According to another aspect, the present disclosure provides a computer-implemented method for determining a structured query language query for a database, the method comprising: receiving a database query in a natural language and database information, the database information comprising a database schema having multiple schema elements; receiving a preliminary query in structured query language corresponding to the input query; selecting one or more schema elements from the multiple schema elements; selecting one or more examples from multiple indexed examples, each example of the multiple indexed examples comprising a respective pair of natural language and structured query language queries, in dependence on respective structural similarities between the preliminary query and the structured query language query of a respective pair of multiple preliminary examples of the multiple indexed examples, wherein the preliminary query and the structured query language query of a respective pair are represented as normalized abstract syntax trees; forming a prompt based on the selected one or more schema elements and the selected one or more examples; and inputting the prompt to a large language model to form an output query in structured query language corresponding to the input query.

This method may allow output queries to be formed using examples in the prompt that have semantic similarity with respect to both the input query and the expected SQL, with the ability to support new domains with limited data.

According to a further aspect, the present disclosure provides one or more computer programs for instructing a computer comprising one or more processors to implement the method above.

According to a further aspect, the present disclosure provides a data carrier storing in non-transitory form the one or more computer programs above.

### BRIEF DESCRIPTION OF THE FIGURES

FIG. 1 schematically illustrates a typical usage scenario of embodiments of the present disclosure.

FIG. 2 schematically illustrates natural language to SQL (NL2SQL) examples from the perspective of a large language model.

FIG. 3 schematically illustrates the architecture of an example of the NL2SQL system described herein.

FIG. 4 schematically illustrates the architecture of schema selection using dynamic database content selection.

FIGS. 5a and 5b schematically illustrate examples of how the similarity between two different SQL queries can be computed using normalized abstract syntax trees (ASTs).

FIG. 6 schematically illustrates using an AST-similarity score to iteratively determine and improve problematic queries.

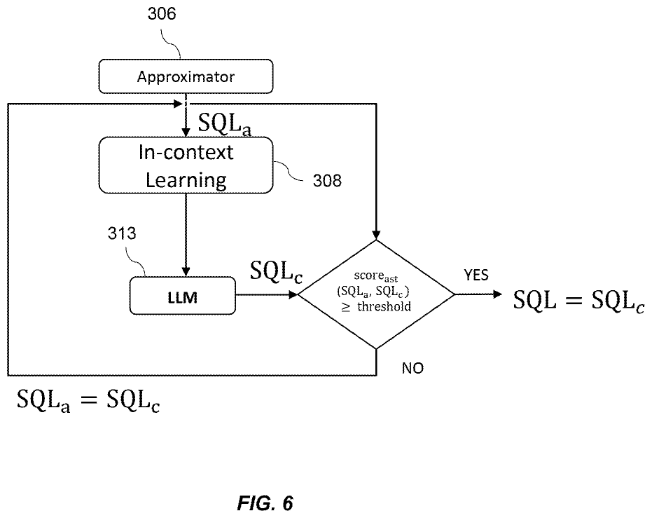

FIG. 7 schematically illustrates an example of a computer-implemented method for determining a structured query language query for a database.

FIG. 8 schematically illustrates an example of a computing device suitable for implementing the methods described herein.

### DETAILED DESCRIPTION

Embodiments of the present disclosure include Text-to-SQL semantic parsing, particularly from the perspective of LLMs for SQL formation. Described herein are approaches for Retrieval Augmented Generation (RAG) based on a dynamic schema and an optional DB-content selection strategy, an Abstract Syntax Tree (AST) scoring approach for re-ranking retrieved examples, and a SQL refinement strategy for offering quality guarantees to the end-user.

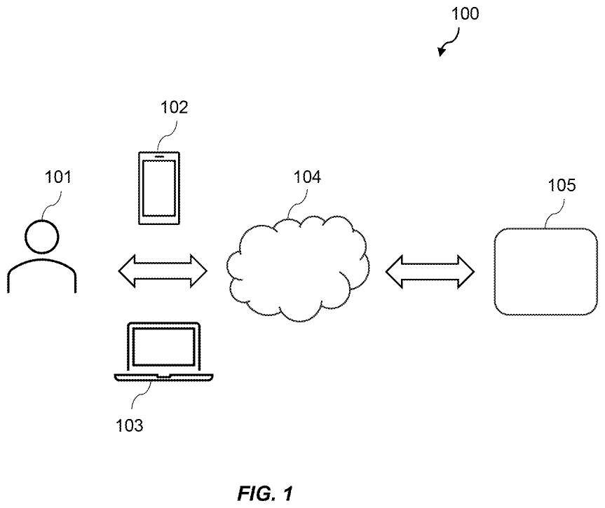

A typical usage scenario can be seen in FIG. 1. In this exemplary system 100, a user 101, using one or more of various computing devices 102, 103, accesses (in this example via a network such as the internet 104) an NL2SQL platform 105. In this example, the platform 105 is cloud-based. In other examples, the platform may be implemented as traditional hardware.

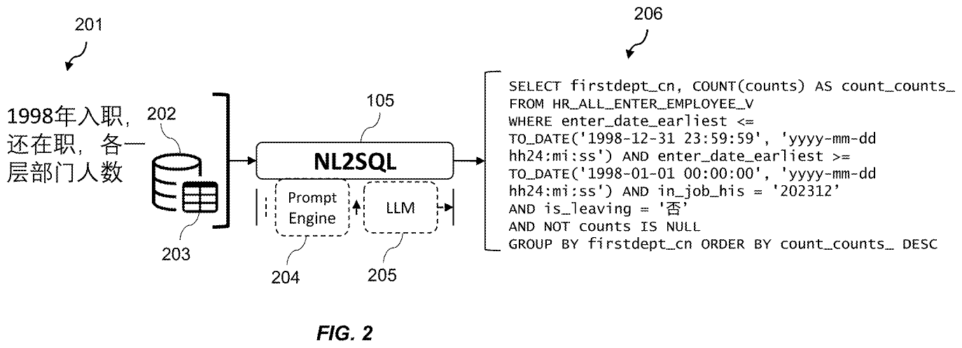

Further details of the operation of the NL2SQL platform are shown in FIG. 2. A natural language question 201 that is provided by the user and a database schema 202 (and, optionally, the database content 203) are received by a server, which executes the Text-to-SQL process (shown as NL2SQL 105) and returns a SQL query 206 to the user (and/or subsequently, executes the SQL query against the database, and provides the user with the results). For the remainder of this document, the terms Text-to-SQL and NL2SQL will be used interchangeably.

In the example of FIG. 2, users ask questions, in a natural language (i.e. a language that has been developed naturally in use, as opposed to an artificial or computing language) against a database whose schema can be in one natural language (for example, English), and database (DB) content in another (e.g. Chinese). The NL2SQL module 105 comprises a prompt engine 204 and an LLM 205. The prompt engine 204 is responsible for constructing the prompt (i.e. input) to the LLM 205. The LLM is tasked with outputting the expected SQL 206 that addresses the original natural language query (also referred to herein as the input question) 201. The user is provided with the final answer(s) when the resulting SQL is executed by the executable DB.

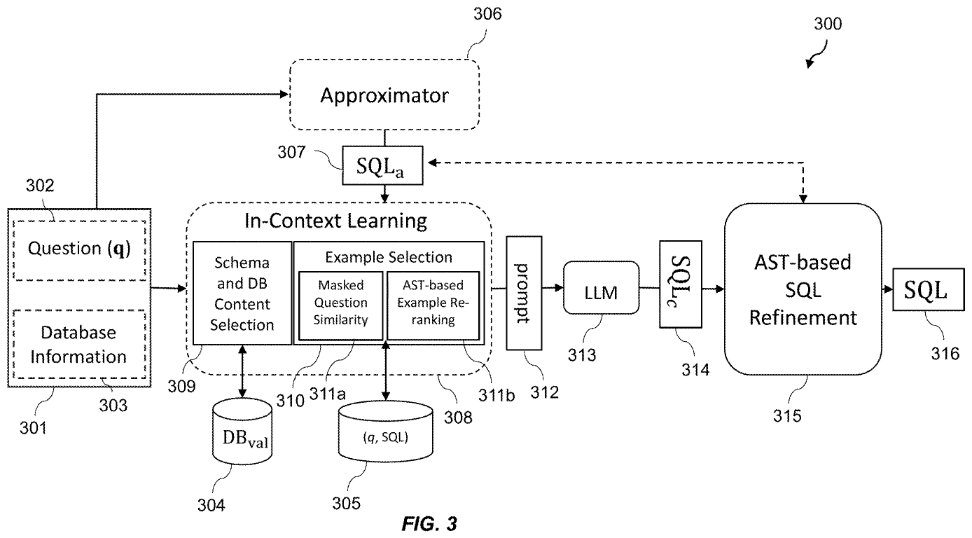

FIG. 3 schematically illustrates further details of the architecture of an exemplary NL2SQL system. In this example, the architecture comprises the following components.

The input is shown at 301 and in this example comprises a natural language question (q) 302 and DB information 303. The DB information includes the DB schema and, optionally, DB values, DBᵥₐₗ, shown at 304.

An examples index 305 comprises a database of multiple indexed (q, SQL)_{j-|X|} examples, each example comprising a natural language question coupled with its corresponding SQL query.

Approximator 306 is an NL2SQL semantic parser. The approximator is responsible for computing a preliminary SQL query, SQLₐ 307, given the input original question 302 and DB information 303. An exemplary approximator suitable for use in the present approach is described in Gao, D., Wang, H., Li, Y., Sun, X., Qian, Y., Ding, B., & Zhou, J. (2023), “Text-to-SQL Empowered by Large Language Models: A Benchmark Evaluation”, CoRR, abs/2308.15363. Other suitable approximators may be used.

An in-context learning module 308 is responsible for forming the input prompt 312 to the LLM 313 of interest given the input question 302 and DB information 303.

In this example, the in-context learning module 308 comprises the following sub-modules 309 and 310.

A schema and, in some embodiments, DB content selection module 309 is responsible for selecting the most suitable schema elements and, in some embodiments, DB content for the given input 301 for inclusion in the prompt. In some embodiments, the module 309 may further enrich the resulting prompt 312 by providing candidate SQL operations for the selected schema elements.

An example selection module 310 is responsible for identifying the most suitable set of (q, SQL) examples to be included in the resulting prompt 312 for maximising the probability of the LLM to generate the correct SQL corresponding to the input question. In this example, the example selection module 310 comprises a masked question similarity module 311a and an AST-based example re-ranking module 311b. The masked question similarity module 311a is a semantic search module which retrieves relevant (q, SQL) examples based solely on the embedding similarity of the input question with questions that are stored in the (q, SQL) examples index. The AST-based example re-ranking module 311b is responsible for re-ranking the examples retrieved by question embeddings, using the similarity of normalized SQL ASTs.

LLM 313 is the end-model responsible for providing the expected SQL that addresses the input given the input prompt 312. Here, the output of the LLM is a generated query SQLc 314 (after a single iteration).

In an embodiment of the present disclosure, the output SQLc 314 can be input to an AST-based SQL refinement module 315. The module 315 is responsible for using AST-similarity score to iteratively determine and improve problematic queries before these are executed by the executable DB. The SQL query 316 produced as the output of this module is finally executed by the DB instance.

The NL2SQL system 300 therefore provides a SQL query 316 that responds to the user's natural language question 302. The output SQL query 316 can be provided to a user, and/or executed by a database instance to return one or more database results. The database result(s) may be output by the computing device. The output query 316 and/or the database result(s) may be used by a computing device for further operations. In some implementations, one or more actions may be performed by the computing device in response to the database result(s). Exemplary actions may comprise one or more of the following.

The device may provide a conversational interface by using a LLM to synthesize an answer in natural language based on the structured database result(s).

The device may provide data insights by visualising the database result(s), and/or enable users to export the resulting data records.

The device may further prompt the user with an option of whether the output database result(s) answer the input question. For database result(s) with positive user feedback, the corresponding input question and output SQL query can be added to the existing set of examples to be selected for future queries.

The device may provide the user with an option to re-run the pipeline by phrasing the input question in a different way, in case a problematic query is detected using the AST-based SQL refinement module 315.

A typical scenario, according to which the end-system can achieve its functionality, will now be described.

As mentioned above, the user provides database information 303 comprising the schema information of a particular DB. This can be done either along with their input question 302, or as a separate step.

The user may also have the option to provide DB content relevant to the input database. The user may also have the option to provide additional (question, SQL) pairs that can be used for enriching the existing examples index. The user may also have the option to provide the confidence that they are expecting for the resulting SQL queries.

At the start of the main runtime, the user enters their question 302 (q), for example in a question box. The approximator 306 computes a preliminary SQL query, SQLₐ, given the original question and DB combination.

The schema and DB content selection module 309 expects the question 302 and the DB information 303 (including the DB content 304, if this is provided by the user) as input. The module 309 uses a set of different retrieving strategies to select the most suitable DB schema elements and optionally DB values to be included in the prompt 312.

In some embodiments, SQL operations that can be relevant to the selected schema elements can also be included in the prompt. These preliminary SQL operations may be referred to as SQL Semantic Predictions (SSP), as described in Vougiouklis, P., Papasarantopoulos, N., Zheng, D., Tuckey, D., Diao, C., Shen, Z., & Pan, J. (2023 November), “FastRAT: Fast and Efficient Cross-lingual Text-to-SQL Semantic Parsing”, Proceedings of the 13th International Joint Conference on Natural Language Processing and the 3rd Conference of the Asia-Pacific Chapter of the Association for Computational Linguistics (Volume 1: Long Papers) (pp. 564-576), Nusa: Association for Computational Linguistics, doi: 10.18653/v1/2023.ijcnlp-main.38.

The example selection module 310 expects the input question 302 and a preliminary SQL query, SQLₐ 307, as input. After computing similarities between the input question 302 and SQLₐ 307 with the example questions and SQL queries in the maintained index of examples 305, the example selection module 310 selects the most suitable set of (q, SQL) examples that should be included in the resulting prompt 312, for this particular input 301.

The resulting prompt 312 is formed using the selected DB schema elements (optionally along with their corresponding SSP labels, in case relevant) and optionally selected DB values, the selected (q, SQL) examples, and the original input question (q) 302.

LLM 313 processes the resulting prompt 312. The LLM 313 outputs a candidate SQL, SQL_{c} 314. This output SQL query may be provided to the user, or optional refinement of the output SQL may be performed as described below. The final SQL can optionally be executed by a database instance if the database content is available.

The AST-based refinement module 315 expects SQLₐ 307 and SQL_{c} 314 as inputs. If the AST-based similarity score between them meets the expected threshold then SQL_{c} is returned as output, such that SQL=SQL_{c}. Otherwise, an iterative process may be initialised by running the in-context learning modules 309, 310 again and re-prompting the LLM, until the corresponding threshold conditions are met. The threshold conditions (with respect, also, to the number of iterations) can also be user-defined.

The final SQL query 316 is either returned to the user and/or the final SQL query 316 can be executed by the DB instance, if the DB content 304 is available.

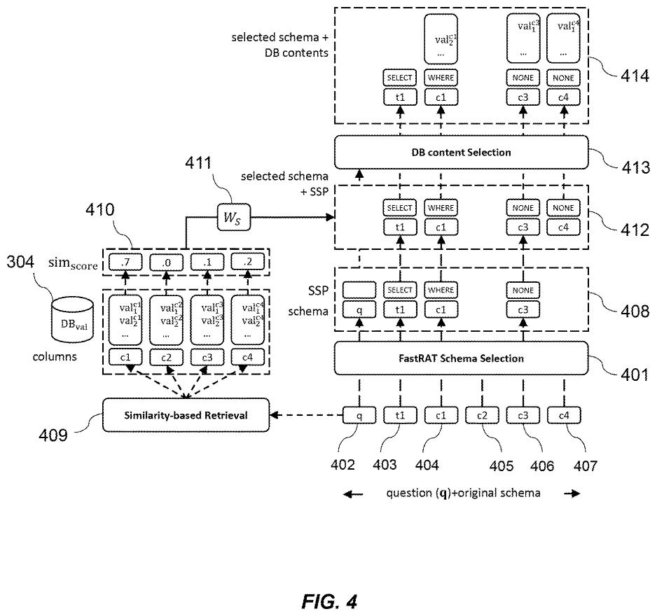

The operation of the schema and DB content selection module 309 will now be described in more detail with reference to FIG. 4, which shows an exemplary architecture for the schema selection module using dynamic DB content selection.

The module 309 can use a hybrid search strategy that selects one or more schema elements, which may comprise one or more tables and/or column of the database, given a test question to minimise lengthy and potentially irrelevant schema elements input to LLMs, while also maintaining a high recall.

In the following,

$${c}_{1}^{1} , {c}_{2}^{1} , … , {c}_{{C}_{1}}^{1} , … , {c}_{{C}_{T}}^{T}$$

are columns of a DB, where C₁, . . . , C_{T}∈N are the indices of the last column of table t₁ and t_{T} respectively (assuming a serialized version of the DB schema). t₁, t₂, . . . , t_{T} are tables of a DB. (qⱼ, sⱼ)∀j∈[1, |X|] is a candidate (question, SQL) pair, which may be part of an index, X, of training examples.

Let

$${r}_{j}^{i}$$

be a semantic representation of a column aggregating the table name that it belongs to, tᵢ, its semantic name,

$${c}_{j}^{i}$$

and its corresponding value set in the relevant DB,

$${v}_{{c}_{j}^{i}} ,$$

as follows:

$${r}_{j}^{i} = \{ {t}_{i} ⋃ {c}_{j}^{i} ⋃ {v}_{{c}_{j}^{i}} \vert i ∈ [ 1 , T ] and j ∈ [ 1 , {C}_{i} ] \}$$

where C₁, . . . , C_{T} ∈N are the indices of the last column of table t₁ and t_{T} respectively.

Given an input query or question, q, the most relevant columns can be retrieved using a similarity score between the question and each column. In this example, the similarity score used is a

$${score}_{B M 25} ( {r}_{j}^{i} , q ) ∀ i ∈ [ 1 , T ]$$

and j∈[1,Cᵢ] score between the question and each column (see for example Harman, D. K. (1995), Overview of the third text Retrieval conference (TREC-3), National Institute of Standards and Technology, Gaithersburg, MD. doi: https://doi.org/10.6028/NIST.SP.500-225). With this problem formulation, a table is retrieved if any of its columns are retrieved. The table is then also included as a schema element in the prompt.

While retrieving schema elements based on a similarity score alone, such as on scoreBM25, (as described in Harman, D. K. (1995), Overview of the third text Retrieval conference (TREC-3), National Institute of Standards and Technology, Gaithersburg, MD. doi: https://doi.org/10.6028/NIST.SP.500-225) can work when keyword-matching signals are sufficient, it may in some instances fail to capture the semantic relevance, especially when tables, columns and values are not explicitly mentioned in the question. The semantic search for schema selection uses a comprehension of the relevance between heterogeneous schema elements and the question, in addition to the interactions across them. To this end, a trained parser can inherently be a semantic search model for retrieving a sub-schema, where columns and tables are extracted from the approximated query SQLₐ.

Such an approach can alleviate the effort of training a separate ranking model. In this example, the approximator is a semantic parser which is performing reasonably on the task and can provide the preliminary query SQLₐ, whose structure would assimilate the structure of the expected final query. The number of columns to be retrieved by score_{BM25} can be dynamically determined as proportional to the number of unique columns in SQLₐ. A sub-schema is then obtained by merging the elements selected by score_{BM25} with the elements from the approximated query. Based on the selected tables, primary and valid foreign keys that are absent from the selected sub-schema can be optionally further included.

The module 309 may in some implementations operate as a hybrid model and a similarity-based retriever, which instead of directly merging the schema elements that are returned by the similarity-based retrieval with the schema elements included in SQLₐ, can aggregate the scores of two different retrieving strategies.

As shown in FIG. 4, the FastRAT model described in Vougiouklis, P., Papasarantopoulos, N., Zheng, D., Tuckey, D., Diao, C., Shen, Z., & Pan, J. (2023 November), “FastRAT: Fast and Efficient Cross-lingual Text-to-SQL Semantic Parsing”, Proceedings of the 13th International Joint Conference on Natural Language Processing and the 3rd Conference of the Asia-Pacific Chapter of the Association for Computational Linguistics (Volume 1: Long Papers), (pp. 564-576), Nusa: Association for Computational Linguistics, doi: 10.18653/v1/2023.ijcnlp-main.38, can be used, as illustrated at 401. This model 401 exploits a decoder-free architecture for efficient text-to-SQL parsing. While the monolingual version of FastRAT is based on a BERTLARGE encoder and its cross-lingual variant on an XLM-ROBERTa-large encoder, FastRAT is transferable to any encoder based on a Masked Language Model (MLM).

The input to the FastRAT schema selection model 401 is the original natural language question 402 and input database schema comprising multiple schema elements 403, 404, 405, 406, 407. Given a concatenation of the input natural language question q 402 with the column and table names of a DB schema (c1 404, c2 405, c3 406, c4 407 and t1 403 respectively), the SQL operation in which each column c1, c2, c3, c4 of the input schema would participate in the expected SQL query is computed. In FIG. 4, the selected schema and relevant SQL operations determined using the FastRAT schema selection 401 are shown at 408. The relevant SQL operations for table t1 and columns c1 and c3 are SELECT, WHERE and NONE respectively. Columns c2 and c4 have not been selected via this first schema selection method.

The SQL operation labels can be used as course, proxy input at subsequent steps of the pipeline. These SQL operation labels may be referred to as SQL Semantic Prediction (SSP) labels, for example as described in Yu, T., Wu, C.-S., Lin, X. V., Wang, B., Tan, Y. C., Yang, X., Xiong, C. (2021), “GraPPa: Grammar-Augmented Pre-Training for Table Semantic Parsing”, International Conference on Learning Representations, https://arxiv.org/abs/2009.13845.

In cases of longer DB schemata, FastRAT and similar encoder models may be adapted to process schema elements in a parallelised manner. This may be performed by a schema splitting strategy in order to scale the model up to the requirements of schemata having hundreds of columns.

In one example, the input embedding matrix of the model is augmented with two special schema-completion tokens, [full_schema] and [part_schema], which are used for signalling cases in which a full and a partial schema are provided as input respectively. The goal is to split a schema with

$${\sum }_{j = 1}^{T} {C}_{j}$$

columns into rₘ spits subject to each split having a maximum, pre-defined number of columns r. Each split may comprise the question tokens, a single schema-completion token, the table names of the input DB and up to a maximum r number of columns allocated to this particular split.

The returned schema splits along with the SSP labels corresponding to the columns that are allocated to each split are treated as independent data instances during training. At test time, an input schema may be split, and a batch of the resulting splits is provided to the model as input. After aggregating the results from all splits, the SSP label for each column in the DB schema can be obtained.

In FIG. 4, the FastRAT schema selection approach is coupled with similarity-based retrieval in a hybrid schema selection approach. The original natural language question 402 and input database schema comprising multiple schema elements 403, 404, 405, 406, 407 are also input to a similarity-based retrieval module 409.

The similarity-based retrieval module computes a similarity score sim_{score}, shown at 410, for each column c1, c2, c3, c4 in the provided schema. In this example, sim_{score} is computed taking into consideration a sample of DB content for each column of DBᵥₐₗ 304.

In this example, the FastRAT schema selector predicts an SSP label for each input item (i.e. table 403 and columns 404-407). For each input item, the FastRAT module 401 outputs a probability distribution across all possible SSP labels, which is modelled as a softmax function.

Among the set of possible SSP labels, there is also the NONE label. The NONE SSP label is assigned to columns that have lower probability to be included in the expected SQL query. For determining the final ranking for the involved schema elements, the likelihood that a particular schema element would be assigned this NONE SSP label can also be considered.

The similarity scores at 410 are then weighted by setting a hyper-parameter W_{S} 411. The hyper-parameter W_{S} can be used for weighting, for a particular column, the SSP scores (i.e. probabilities of SSP labels) coming from an MLM with a similarity score, such as score_{BM25}.

Final column selection can be carried out by ranking column importance, for example by using:

$${W}_{S} {score}_{B M 25}^{j} + [ 1 - P ( SSP ( {c}_{j}^{i} ) = NONE ) ] ∀ i ∈ [ 1 , T ] and j ∈ [ 1 , {C}_{i} ]$$

where

$${score}_{B M 25}^{j}$$

denotes normalized score_{BM25} scores for selecting the

$${c}_{j}^{i}$$

column and

$$P ( S S P ( {c}_{j}^{i} ) = NONE )$$

denotes the probability of the NON SSP label to be selected for column,

$${c}_{j}^{i} .$$

Intuitively, a column with high

$$P ( SSP ( {c}_{j}^{i} ) = NONE )$$

is a column which the MLM would regard as not relevant (i.e. low probability of being selected) for the expected SQL query for the input question and DB.

In the example shown in FIG. 4, the final columns selected at c1, c3 and c4, along with table t1 which the columns are part of, as shown at 412. These columns and table are the selected schema elements.

Any predicted SQL operations, for example in the form of SSP labels (e.g. SELECT, WHERE), for the selected schema elements can be included in the resulting prompt to be input to the LLM. For instance, the SQL operations of SELECT and WHERE in the case of t₁ and c1 respectively, in the example of FIG. 4, can be included in the prompt.

DB content selection from the DB content 304 can be performed using a hybrid retriever 413 on-top of the selected columns.

DB values may be selected as follows. In case content for the DB of interest is made available, values can be selected for columns in a schema (or a sub-schema) by performing keyword matching between input questions and values from the provided DB content (i.e. DBᵥₐₗ in FIGS. 3 and 4). This is based on the assumption that LLMs can generalise to unseen values given a set of representative values. Value selection can also be performed by providing additional information for LLMs to discern covert differences among columns.

Keyword matching is performed for each one of the selected columns, (or, for all columns in a database schema, in case schema selection is omitted). For each keyword matching round (i.e. one round per each schema element), the input natural language query and one or more values from the corresponding database content are considered.

The final selected schema elements (c1, c3 and c4 and the table t1 they are part of) along with any corresponding SSP labels and the selected DB content

$$( i . e . {val}_{2}^{c 1} , {val}_{1}^{c 3} and {val}_{1}^{c 4} for c 1 , c 3 and c 4 respectively )$$

for the selected columns are shown at 414 in FIG. 4. Candidate DB values

$${val}_{1}^{c 1} , {val}_{2}^{c 3} and {val}_{2}^{c 4}$$

are not selected.

The operation of the AST-based example re-ranking module 311b will now be described.

As for in-context learning, the goal is to identify the most suitable set of

$${X}^{⋆} = \{ ( {q}_{1}^{⋆} , {s}_{1}^{⋆} ) , … , ( {q}_{e}^{⋆} , {s}_{e}^{⋆} ) \}$$

question-SQL pairs from an index, X, of training examples s.t. X*⊆X, for maximising the probability of an LLM to predict the correct SQL given the input q and DB combination, as follows:

$${X}^{⋆} = arg {max}_{X} p ( s \vert q , DB , X )$$

From the perspective of ranking, the relevance score between a candidate example (qⱼ, sⱼ)∈X and the input q and DB combination is determined.

Vanilla semantic search is usually based solely on context-independent question embeddings, and is agnostic to the similarity of selected examples from X with respect to the structure of the expected SQL query s that addresses the input (q, DB). In order to alleviate shortcomings associated with retrieving examples based solely on masked question similarity, the formulation of the approach described herein considers similarities across both the question and SQL part of each candidate (qⱼ, sⱼ) example.

The present approach for re-ranking examples retrieved by question embeddings uses the similarity of normalized SQL ASTs. It is assumed that the approximated preliminary query SQLₐ can be structurally similar to the expected SQL output query, and the former is used to compute: score_{AST}(s′, sⱼ) for each candidate sⱼ. AST represents the hierarchical structure of code in a tree form and can be applied to evaluation metrics for code generation tasks. Consequently, it can provide a formal and complete representation of the SQL structure.

SQL queries that share identical abstract meanings may not align with the same syntactic structure in ASTs, thus posing a challenge for measuring the relevance of candidate examples through AST differencing in some cases.

Although in some cases it may be infeasible to enumerate all possible transformations from a query to another equivalent form, undesired operations in subsequent tree editing can be reduced by applying the following normalisation within each AST.

In a first step, identifiers are unified. For example, identifiers, such as table and column names, can be converted to lowercase. When a query or sub-query pertains to a single table, unnecessary references preceding identifiers can be removed. For example, <table>.<column> is substituted with <column>.

Aliases are then resolved. Sub-trees that create aliases can be removed and aliases can be mapped to the original table or column names. If an alias references an expression, such as COUNT (*), the alias node can be replaced with a copy of the sub-tree of that expression.

JOIN operations can then be reordered. Tables can be inner joined in different orders while the resulting queries are equivalent in execution. To address this concern, nodes of tables and keys associated with JOIN operation(s) are rearranged in an alphabetical order to ensure deterministic transformations.

Identifiers and values can be masked. For cross-domain settings wherein databases at inference time are unseen in the training set, nodes of values and identifiers can be masked out, after alias resolution. In this case, reordering JOIN operations is not a prerequisite.

Given two normalized ASTs, the Change Distilling algorithm (as described in Fluri, B., Wursch, M., PInzger, M., & Gall, H. (2007), “Change Distilling: Tree Differencing for Fine-Grained Source Code Change Extraction”, IEEE Transactions on Software Engineering, 33, 725-743. doi: 10.1109/TSE.2007.70731) is applied that computes a list of tree edit operations to transform the source AST to the target AST. Types of tree edit operations include: insert, delete, alignment, move and update. The move operation relocates a node to a different parent while moving a node within the same parent is an alignment. Therefore, the similarity between ASTs can be calculated as the ratio of alignments to the total number of operations within the list.

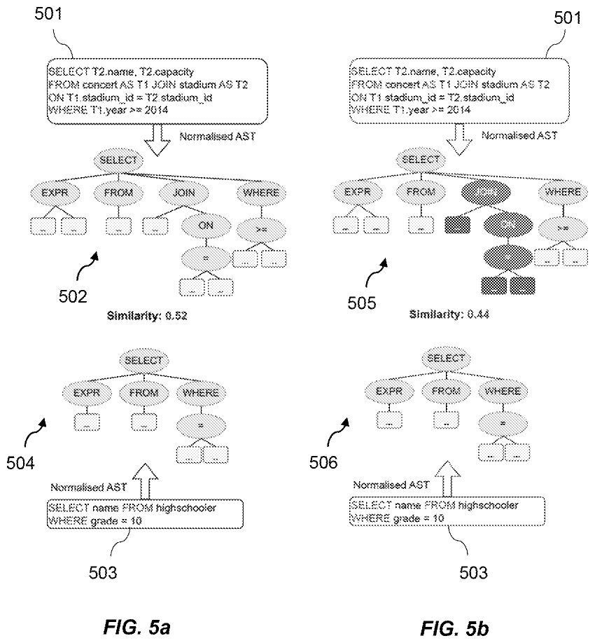

An example of how the similarity between two different SQL queries 501 and 503 can be computed using normalized ASTs is provided in FIGS. 5a and 5b.

In FIG. 5a, the different nodes and types of AST changes are weighted uniformly. This results in a similarity score of 0.52 for the ASTs 502 and 504.

This similarity formulation also allows for assigning different weights to various types of changes or nodes in the ASTs. For instance, in the case that similarity across JOIN operations is regarded as more crucial, the involved nodes and their relevant edges can be weighted higher. In the case shown in FIG. 5b, the similarity across JOIN operations is weighted higher. This results in a similarity score of 0.44 for the ASTs 505 and 506.

Put generally, candidate (question, SQL) examples are originally selected using (masked) embedding similarity between the input query, in natural language, and the natural language questions of the pairs that are maintained in the examples index. After any preliminary examples are selected, they are re-ranked using the AST similarity score of the normalized ASTs of the preliminary SQL query, and the SQL query of each one of the selected, preliminary (question, SQL) pairs (i.e. one AST similarity score for each candidate).

One or more examples, each comprising a (question, SQL) pair, may be selected in this way and included in the prompt.

When SQL_{c} is output from the LLM, it can optionally be further refined. This can be done using a similarity score between the preliminary query SQLₐ and the output query SQL_{c}, as will be described in more detail below.

In real-world scenarios, attempting multiple query executions against a SQL instance is not always feasible. Furthermore, access to an executable database environment is not always available across all deployment requirements. In order to alleviate these challenges, an exemplary iterative methodology for using the AST similarity score can automatically identify and improve problematic SQL queries without requiring access to an executable DB, as follows.

During each iteration, the AST similarity of the approximated SQL query with the one generated by the LLM, scoreₐₛₜ (SQLₐ, SQL_{c}) is computed.

If the score meets or exceeds an expected threshold (which may be predetermined, for example based on quality standards), the user is provided with SQL_{c}. If the score is lower than the expected threshold, then the entire pipeline can be re-run using SQL_{c} as the approximated SQL query (i.e. SQLₐ=SQL_{c}).

The process can be stopped (i.e. SQL_{c} is outputted as the final query) when scoreₐₛₜ (SQLₐ, SQL_{c})≥threshold, or in case a pre-determined number of iterations is met.

FIG. 1 schematically illustrates using the AST-similarity score to iteratively determine and improve problematic queries.

In case scoreₐₛₜ is lower than the expected threshold, in high-precision settings, the user can be provided with an empty SQL, along with an appropriate warning message displaying the system's inability to generate the requested SQL query. Alternatively, the resulting SQL could be output with an accompanying note advising the user that some modifications might be needed, and/or that the system's confidence in the result is lower.

In case scoreₐₛₜ is greater than or equal to the threshold, SQL_{c} is provided as the final SQL query.

This iterative pipeline can in some implementations offer quality guarantees for commercial environments that may require meeting precision scores greater than 90%.

This structural similarity between ASTs representing queries is applicable in two cases in the approach described herein. Firstly, in the selection of examples. In this case, it involves the preliminary SQL query and the SQL query of each one of the candidate (question, SQL) example pairs. Secondly, in the output SQL refinement. In this case, it involves the preliminary SQL query (SQLₐ), and the resulting SQL coming from the LLM (SQL_{c}), at a particular iteration round. In both cases, the structural similarity of the ASTs may be determined in the same way. Preferably, the structural similarity is determined in dependence on the sizes of the respective abstract syntax trees and the number of changes between the respective abstract syntax trees.

An embodiment of the present disclosure can be implemented as the NL2SQL module of a business intelligence (BI) platform. Assuming the existence of an LLM capable of general instruction-following capabilities, the module can achieve its functionality as an online service, expecting DB information (with or without the relevant DB content) as input during its initialization.

The user may also choose to upload a set of (question, SQL) examples that can be included in the examples index maintained by the service (see FIG. 3). The examples index may be hosted as a vector database, responsible for efficiently storing and querying vectors (i.e. embeddings). Vector representations of the questions that are stored in the examples index may be computed using dense encoders, based on self-attentive architectures (see for example Karpukhin, V., Oguz, B., Min, S., Lewis, P., Wu, L., Edunov, S., Yih, W.-t. (2020 November), “Dense Passage Retrieval for Open-Domain Question Answering”, in B. Webber, T. Cohn, Y. He, & Y. Liu (Ed.), Proceedings of the 2020 Conference on Empirical Methods in Natural Language Processing (EMNLP), (pp. 6769-6781), Online: Association for Computational Linguistics, doi: 10.18653/v1/2020.emnlp-main.550). Other methodologies for computing vector representations and re-ranking relevant passages may alternatively be used.

After its initialization, the NL2SQL module is responsible for outputting the SQL that addresses NL questions against the provided DB schema. The resulting SQL may be provided to the user as is, or it may be subjected to subsequent post-processing and refinement operations. In case the resulting SQL does not meet the expected, quality standards indicated by the SQL refiner, the user may be provided with a warning message indicating that the SQL query might require further attention.

In the case that the corresponding DB content is provided, the resulting SQL query may be executed against the provided DB, and the user may be provided with the relevant results. These results may be processed by subsequent modules of the platform, responsible for visualizing them using infographics or various chart types.

An embodiment of the present disclosure can be also implemented as a prompting (-enhancement) module for Text-to-SQL tasks. Given a DB schema (with or without DB content) and a natural language question as input, this prompting module may be responsible for coming up with the most suitable LLM input prompt. The prompting module may facilitate a schema selection functionality by including in the resulting prompt only table or column elements, from the original DB schema, that are relevant for addressing the input question. Schema selection may consider hybrid methodologies for coupling the results of a dense or sparse retriever, or combinations thereof, with a model predicting candidate SQL operation labels for each schema element. The retrievers may consider a semantic representation of each column in the original DB schema, aggregating the table name that it belongs to, tᵢ, its semantic name, cⱼⁱ, and its corresponding value set in the relevant DB.

The resulting prompt may be further enriched by including candidate SQL operation labels, or SSP labels, for the selected schema elements or suitable DB content relevant to this (question, DB) input combination. The candidate SQL operation labels may be provided using an SSP prediction model capable of processing a serialized version of the input question and DB schema, and, subsequently, outputting an SSP or SQL operation label, on-top of each schema item. Finally, in case DB content is provided by the user, the DB content selection functionality may be implemented as a sparse retriever that considers the similarity of the input questions against all the available values for each one of the columns that are selected from the original DB.

Finally, the resulting prompt may be enriched with the most suitable examples from a maintained index of (question, SQL) pairs. The examples index may be hosted as a vector database, responsible for efficiently storing and querying vectors (i.e. embeddings). Re-ranking examples that should be included in the LLM prompt may be carried out using the similarity of normalized SQL ASTs by computing the number of tree edit operations. In the case that the user is interested more in the correctness of particular aspects of the resulting SQL query (for instance, JOIN operations), the tree-edit distance formulation may also be adjusted to assign different weights to different types of changes or nodes in the involved ASTs.

In an embodiment of the present disclosure, the system may be implemented as an NL2SQL refinement or quality-checking module. This module may be activated in case an executable DB environment (i.e. for ensuring the executability of a resulting SQL query) is not available, or in case the relevant BI platform, or its NL2SQL module, offers a fast-processing mode that does not require the resulting SQL queries to be compiled and executed. This NL2SQL refinement or quality-checking module may be implemented using an approximator in the form of a semantic parser that has been explicitly trained on SQL query prediction, or as a more general, instruction-following LLM, whose semantic parsing capabilities are based on prompting and/or in-context learning. The quality of the resulting SQL may be estimated by computing the AST similarity score of the preliminary SQL query, that is generated by this semantic parser with the final SQL query (SQL_{c}) which is produced by the full NL2SQL service, before or after the application of any deterministic post-processing operations. In case the AST similarity score is lower than a threshold, which in-turn can be defined based on the quality-expectations of the user, then the entire pipeline is re-run using SQL_{c} as a new preliminary, SQL query.

The quality of the resulting SQL may be also determined by computing the AST similarity score of the preliminary SQL query against the SQL of all the available (question, SQL) pairs of the example index, in an exhaustive-search mode, or against a selected subset of (question, SQL) examples. A selected subset of (question, SQL) examples may be obtained by selecting examples based on the similarity of their question-part with the input NL question using a dense or sparse retriever or combinations thereof. In case certain thresholds are not met after aggregating the AST scores across the relevant (question, SQL) pairs, then the NL2SQL service may return a warning message indicating potential issues with the SQL query that is about to be generated. AST similarity scores across a set of (question, SQL) examples may be aggregated using conventional aggregation functions, such as mean, median or max.

In an embodiment, the NL2SQL module may be implemented as a local service, which during its initialization, it expects a set comprising one or more DBs as input. At test time, along with a question, in natural language, the user can select the DB to which the input question is relevant. The service may maintain a hash-table which allocates a unique key to each one of the DBs that are loaded during initialization. The service may support functions for the user to upload new DBs and additional (question, SQL) pairs, during regular uptime.

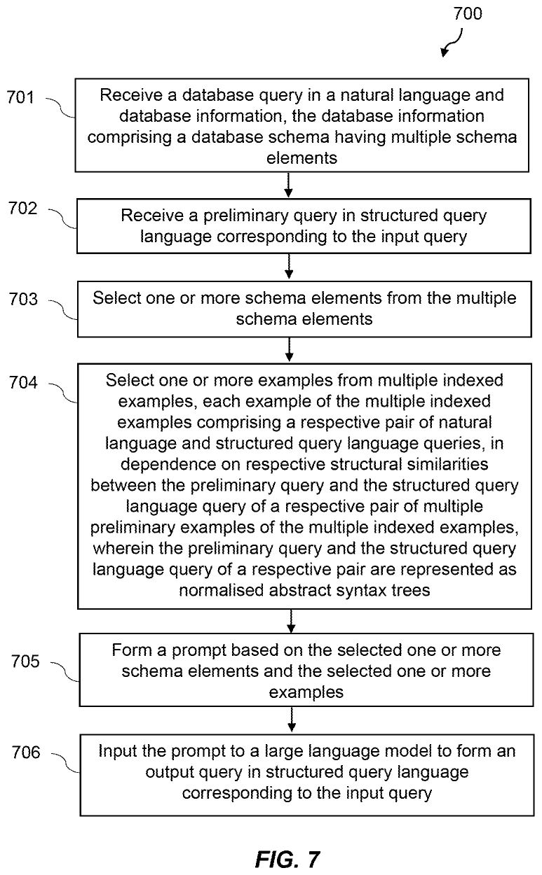

FIG. 7 shows an example of a computer-implemented method for determining a structured query language query for a database.

At step 701, the method comprises receiving a database query in a natural language and database information, the database information comprising a database schema having multiple schema elements. At step 702, the method comprises receiving a preliminary query in structured query language corresponding to the input query. At step 703, the method comprises selecting one or more schema elements from the multiple schema elements. At step 704, the method comprises selecting one or more examples from multiple indexed examples, each example of the multiple indexed examples comprising a respective pair of natural language and structured query language queries, in dependence on respective structural similarities between the preliminary query and the structured query language query of a respective pair of multiple preliminary examples of the multiple indexed examples (that are preliminary selected examples), wherein the preliminary query and the structured query language query of a respective pair are represented as normalized abstract syntax trees. At step 705, the method comprises forming a prompt based on the selected one or more schema elements and the selected one or more examples. At step 706, the method comprises inputting the prompt to a large language model to form an output query in structured query language corresponding to the input query.

In an embodiment of the present disclosure, the method also comprises executing the output query by the database instance corresponding to the database information. This may return one or more results from the database. An operation may then be performed by the computing device using the returned result(s).

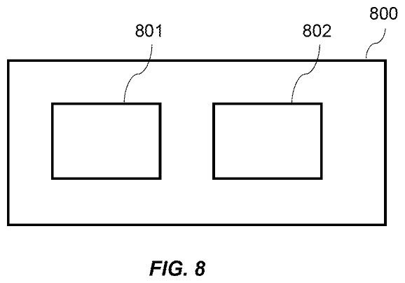

FIG. 8 shows an example of a computing device 800 configured to implement the methods described herein. The device 800 comprises a processor 801 and a memory 802.

The device 800 may in some implementations also comprise a transceiver that is capable of communicating over a network with other entities. Those entities may be physically remote from the device 800. The network may be a publicly accessible network, such as the internet. The entities may be based in the cloud. These entities may be logical entities. In practice they may each be provided by one or more physical devices such as servers and data stores, and the functions of two or more of the entities may be provided by a single physical device. Each physical device implementing an entity comprises a processor and a memory. The service entity may also be operated in a distributed fashion, across multiple entities.

The memory 802 stores in a non-transient way code that is executable by the processor 801 to implement the respective entity in the manner described herein.

The device 800 may be implemented by hardware or may be service-based computing device, for example it may be implemented as a cloud-based computing device.

Therefore, the method may be deployed in multiple ways, for example in the cloud, on the device, or in dedicated hardware.

The present approach using combinations of a sparse retriever with an in-parallel semantic parser (referred to herein as an approximator) can be used for optimizing the LLM prompt, both with respect to schema pruning by selecting the most relevant schema elements (i.e. by removing unnecessary noise), and to enrich the selected sub-schema with representative DB content and SQL operation labels (which may be referred to as SSP labels) to be included in the LLM prompt.

In prior methods, access to an executable database environment is not always available across all deployment requirements. Furthermore, attempting multiple query executions can result in unnecessary load for the DB instance, negatively impacting its throughput. The approach described herein for computing the expected quality of the resulting SQL query does not rely on the existence of an executable DB, leveraging the AST-similarity score between a preliminary SQL query, which is provided by a SQL approximator, and the resulting SQL at each iteration round.

Conventional LLM prompting for generating SQL without schema selection can result in very lengthy prompts. Longer schemata cannot be processed by smaller LLMs, which have shorter context windows of ≤2048 tokens. Training a sequential binary classification model on top of serialized schema representations can still be challenging since longer schemata would need to be truncated in order to be processed by the involved model. Implementing a column/table retriever using vector database tool does not consider table-column associations that are not mentioned explicitly in the input, and other contextual similarities with the entire schema. Leveraging a hard-column selection strategy (i.e. by completely removing any non-selected columns) can also in some implementations be non-optimal.

Prior solutions which involve extracting values (i.e. DB content) appearing in the question, in a separate LLM prompting step, and including the extracted values in the subsequent prompts can provide an isolated view of the actual DB content for generating a query.

For example selection, considering the similarity of hierarchical structures can significantly refine LLM's performance for the harder Text-to-SQL cases compared to the over-simplified nature of approaches using SQL skeletons, which do not take into consideration structural differences across SQL queries, resulting in information loss during SQL similarities computation.

The above-described method for AST-based example re-ranking can provide for example selection within the context of Retrieval-augmented Generation (RAG), considering the similarity of such hierarchical structures. The proposed approach for re-ranking examples retrieved by masked question similarity, using similarity of normalized SQL Abstract Syntax Trees (ASTs) can ensure semantic similarity with respect to both the input question and the expected SQL, and significantly refine LLMs' performance for the harder Text-to-SQL cases. Edits in the ASTs can be weighted differently given different types changes and AST nodes. This can provide for the ability to support new NL2SQL domains with a minimal amount of training data.

The SQL refinement solution using AST similarity scores can provide an efficient framework for identifying problematic SQL queries, without requiring access to an executable DB, and for refining them, at subsequent iterations. This can improve the quality of the generated SQLs without requiring execution of the resulting queries against a DB instance. It can thus improve execution accuracy, while offering SQL query quality guarantees.

The described approach for schema selection, with optional dynamic DB content selection, may result in more refined input format for LLMs. This may improve SQL execution accuracy and allow supporting schemata having ≥200 columns, which are commonly found in commercial databases. The combination of schema and DB value selection can consistently result in SQL execution accuracy improvements, while significantly reducing the LLM token-processing cost due to shortened schema.

The present disclosure is applicable to platforms that provide users with the ability to upload their DBs, with or without the inclusion of DB content. At test time, given an input natural language question (also referred to as a query), the user is either directly provided with the execution results of the query (in case the relevant DB content has also been made available), or a SQL query which can in turn be executed against a DB instance. The platform can also act as a copilot service, in which the service is expected to provide a preliminary SQL query that the user should be responsible for refining (i.e. by employing either manual or automatic, post-processing pipelines) before executing against a DB instance of interest.

The present disclosure describes in isolation each individual feature described herein and any combination of two or more such features, to the extent that such features or combinations are capable of being carried out based on the present disclosure as a whole in the light of the common general knowledge of a person skilled in the art, irrespective of whether such features or combinations of features solve any problems disclosed herein, and without limitation to the scope of the claims. Aspects of the present disclosure may consist of any such individual feature or combination of features. In view of the foregoing description it will be evident to a person skilled in the art that various modifications may be made within the scope of the present disclosure.

What is claimed is:

1. A computing device comprising one or more processors configured to perform the following steps:
receive a database query in a natural language and database information, the database information comprising a database schema having multiple schema elements;
receive a preliminary query in structured query language corresponding to an input query;
select one or more schema elements from the multiple schema elements;
select one or more examples from multiple indexed examples, each example of the multiple indexed examples comprising a respective pair of natural language queries and structured query language queries, based on respective structural similarities between the preliminary query and a structured query language query of a respective pair of multiple preliminary examples of the multiple indexed examples, wherein the preliminary query and the structured query language query of a respective pair are represented as normalized abstract syntax trees;
form a prompt based on the selected one or more schema elements and the selected one or more examples; and
input the prompt to a large language model to form an output query in the structured query language corresponding to the input query.

2. The computing device as claimed in claim 1, wherein the one or more processors are further configured to refine the output query based on a similarity score between the preliminary query and the output query.

3. The computing device as claimed in claim 2, wherein the one or more processors are configured to compute the similarity score between the preliminary query and the output query by representing each of the preliminary query and the output query as respective abstract syntax trees and determining a structural similarity of the respective abstract syntax trees.

4. The computing device as claimed in claim 2, wherein the one or more processors are further configured to provide the output query for execution by a database instance corresponding to the database information in response to the similarity score meeting a threshold.

5. The computing device as claimed in claim 2, wherein the one or more processors are configured to repeat the steps of receiving the database query, receiving the preliminary query, selecting the one or more schema elements, selecting the one or more examples, forming the prompt, and inputting the prompt using the output query as the preliminary query in response to the similarity score not meeting the threshold.

6. The computing device as claimed in claim 2, wherein the one or more processors are configured to repeat the steps of receiving the database query, receiving the preliminary query, selecting the one or more schema elements, selecting the one or more examples, forming the prompt, and inputting the prompt until the similarity score between the preliminary query and the output query is greater than or equal to the threshold, or until a pre-determined number of iterations has been performed.

7. The computing device as claimed in claim 2, wherein the one or more processors are configured to output a warning message in response to the similarity score being lower than the threshold.

8. The computing device as claimed in claim 1, wherein the one or more processors are configured to select the one or more examples by:
retrieving the multiple preliminary examples from the multiple indexed examples based on an embedding similarity between the input query and a natural language query of a respective pair of the multiple indexed examples; and
re-ranking the multiple preliminary examples based on the structural similarity between the preliminary query and the structured query language query of the respective pair of the multiple preliminary examples represented the normalized abstract syntax trees.

9. The computing device as claimed in claim 1, wherein the one or more processors are configured to select the one or more schema elements based on structured query language operations relevant to each of the multiple schema elements.

10. The computing device as claimed in claim 9, wherein the one or more processors are configured to include the structured query language operations relevant to the selected one or more schema elements in the prompt.

11. The computing device as claimed in claim 1, wherein the one or more processors are configured to determine a structural similarity between the preliminary query and the structured query language query of each pair each represented as respective abstract syntax trees based on sizes of the respective abstract syntax trees and a number of changes between the respective abstract syntax trees.

12. The computing device as claimed in claim 1, wherein the one or more processors are further configured to cause the output query to be executed by a database instance corresponding to the database information.

13. The computing device as claimed in claim 1, wherein the input query is in a different natural language to the database schema.

14. The computing device as claimed in claim 1, wherein the database information further comprises database content, and wherein the one or more processors are further configured to select one or more parts of the database content for inclusion in the prompt.

15. The computing device as claimed in claim 14, wherein the one or more processors are configured to select database values for columns in the selected one or more schema elements by performing keyword matching between the input query and each value of a respective column of the columns.

16. A computer-implemented method for determining a structured query language query for a database, the method comprising:
receiving a database query in a natural language and database information, the database information comprising a database schema having multiple schema elements;
receiving a preliminary query in structured query language corresponding to an input query;
selecting one or more schema elements from the multiple schema elements;
selecting one or more examples from multiple indexed examples, each example of the multiple indexed examples comprising a respective pair of natural language queries and structured query language queries, based on respective structural similarities between the preliminary query and a structured query language query of a respective pair of multiple preliminary examples of the multiple indexed examples, wherein the preliminary query and the structured query language query of a respective pair are represented as normalized abstract syntax trees;
forming a prompt based on the selected one or more schema elements and the selected one or more examples; and
inputting the prompt to a large language model to form an output query in the structured query language corresponding to the input query.

17. A tangible, non-transitory computer-readable medium having instructions thereon which, upon being executed by one or more processors, provide for determining a structured query language query for a database by:
receiving a database query in a natural language and database information, the database information comprising a database schema having multiple schema elements;
receiving a preliminary query in structured query language corresponding to an input query;
selecting one or more schema elements from the multiple schema elements;
selecting one or more examples from multiple indexed examples, each example of the multiple indexed examples comprising a respective pair of natural language queries and structured query language queries, based on respective structural similarities between the preliminary query and a structured query language query of a respective pair of multiple preliminary examples of the multiple indexed examples, wherein the preliminary query and the structured query language query of a respective pair are represented as normalized abstract syntax trees;
forming a prompt based on the selected one or more schema elements and the selected one or more examples; and
inputting the prompt to a large language model to form an output query in the structured query language corresponding to the input query.
